(19) United States
(12) Patent Application Publication
(10) Pub. No.: US 2010/0053195 A1
(43) Pub. Date: Mar. 4, 2010

(54) Filter device, image correction circuit, image dispay device, and method of correcting image

(75) Inventors: Shigeru Harada, Tokyo (JP); Munehisa Yamaguchi, Aichi (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/583,820

(22) Filed: Aug. 26, 2009

(30) Foreign Application Priority Data
Sep. 2, 2008 (JP) P2008-225123

(51) Int. Cl. G09G 5/02; G06K 9/40

(52) U.S. Cl. 345/589; 382/261

(57) ABSTRACT

The present invention provides a filter device allowing unnatural variation in image quality caused by image processing to be suppressed. The filter device including a filter section performing a filtering operation on an input image data so that, when time-varying amount in a total frequency value in a neighboring-classes block configured with a couple of neighboring classes in a histogram distribution of the input image data is equal to or less than a predetermined value, time-varying amount of a frequency value in each of the classes in the neighboring-classes block is suppressed to be equal to or less than a predetermined limitation value.

### CROSS-REFERENCE TO RELATED APPLICATION

The present application claims priority from Japanese Patent Application No. JP 2008-225123 filed in the Japanese Patent Office on Sep. 2, 2008, the entire content of which is incorporated herein by reference.

### BACKGROUND OF THE INVENTION

1. Field of the Invention

The present invention relates to an image correction circuit performing image correction to image data, and a method of correcting an image, a filter device used when such an image correction is performed, and an image display device including such an image correction circuit.

2. Description of the Related Art

In general, a device such as a television receiver, a VTR (video tape recorder), a digital camera, a television camera, or a printer has an image processing function in which an image is output after being subjected to image quality correction (for example, functions such as adjustment in light-dark and contrast, and correction of outline). Mainly, such functions are efficiently applied to an image which is wholly dark and has a low contrast, and an image in which details are blurred.

Among these functions, the contrast adjustment (contrast improvement) is usually performed by correcting a gamma curve (γ curve) which exhibits so-called gamma characteristics. Here, at the time of correcting the γ curve, the degree of a correction amount which is set for each luminance level is called “gain”.

For example, Japanese Unexamined Patent Publication Nos. 2002-366121, 2004-40808, and 2004-282377 each disclose an image processing technique in which a light intensity distribution of an input image is detected as a histogram distribution, and image processing such as contrast adjustment is performed to the input image, based on this histogram distribution. According to these techniques, in particular, a gain is set large for a luminance level having a large frequency value (histogram amount) so that it is possible to improve overall contrast more efficiently.

### SUMMARY OF THE INVENTION

In the image processing using such a light intensity distribution of the related art, for example, the configuration is as indicated with a functional block diagram in FIG. 14. That is, a signal processing section 102 performs a predetermined signal processing (image processing) to a luminance signal Yin through use of a light intensity distribution (histogram distribution) detected based on the luminance signal Yin, in a light intensity distribution detection section 101. Thereby, a luminance signal Yout is produced.

However, in such a method, in the case where the frequency in the histogram distribution is concentrated to a vicinity of a boundary between a couple of luminance level classes immediately adjacent to each other, for example, as indicated with arrows in FIG. 15, when a DC variation is generated, there is a possibility that an issue occurs as will be described below. That is, in the case where the DC variation occurs between the divided luminance level classes immediately adjacent to each other, when image processing is performed based on the histogram distribution, a large variation is produced in a result of the image processing, for example, like the case of the contrast adjustment indicated in FIG. 16.

Specifically, in FIG. 16, a large image variation is brought between a gamma curve 7101 before the image processing and a gamma curve 7102 after the image processing. In such a large image variation, a sense of unnaturalness in the display quality is caused, and an image is unnaturally displayed. Such an issue is particularly obvious in the case where the number of divisions in the luminance level is small.

In view of the foregoing, it is desirable to provide a filter device, an image correction circuit, an image display device, and a method of correcting an image, capable of suppressing unnatural variation in image quality which is caused by image processing.

According to an embodiment of the present invention, there is provided a filter device including: a filter section performing a filtering operation on an input image data so that, when time-varying amount in a total frequency value in a neighboring-classes block configured with a couple of neighboring classes in a histogram distribution of the input image data is equal to or less than a predetermined value, time-varying amount of a frequency value in each of the classes in the neighboring-classes block is suppressed to be equal to or less than a predetermined limitation value.

According to the embodiment of the present invention, there is provided an image correction circuit including: a detection section detecting a histogram distribution of an input image data; a filter section performing a filtering operation on the input image data so that, when time-varying amount in a total frequency value in a neighboring-classes block configured with a couple of neighboring classes in the histogram distribution detected in the detection section is equal to or less than a predetermined value, time-varying amount of a frequency value in each of the classes in the neighboring-classes block is suppressed to be equal to or less than a predetermined limitation value; and an image processing section performing an image processing on the input image data through use of the histogram distribution after the filtering operation in the filter section.

According to the embodiment of the present invention, there is provided an image display device including: a detection section detecting a histogram distribution in an image frame of an input image data; a filter section performing a filtering operation on the input image data so that, when time-varying amount in a total frequency value in a neighboring-classes block configured with a couple of neighboring classes in the histogram distribution detected in the detection section is equal to or less than a predetermined value, time-varying amount of a frequency value in each of the classes in the neighboring-classes block is suppressed to be equal to or less than a predetermined limitation value; an image processing section performing an image processing on the input image data through use of the histogram distribution after the filtering operation in the filter section; and a display section displaying an image based on the image data after the image processing in the image processing section.

According to the embodiment of the present invention, there is provided a method of correcting an image including: detecting a histogram distribution of an input image data; performing a filtering operation on the input image data so that, when time-varying amount in a total frequency value in a neighboring-classes block configured with a couple of neighboring classes in the histogram distribution of the image data is equal to or less than a predetermined value, time-varying amount of a frequency value in each of the classes in the neighboring-classes block is suppressed to be equal to or less than a predetermined limitation value; and performing an image processing on the input image data through use of the histogram distribution after the filtering operation.

In the filter device, the image correction circuit, the image display device, and the method of correcting the image according to the embodiment of the present invention, a filtering operation is performed on the input image data so that, when time-varying amount in a total frequency value in a neighboring-classes block configured with a couple of neighboring classes in the histogram distribution of the image data is equal to or less than a predetermined value, time-varying amount of a frequency value in each of the classes in the neighboring-classes block is suppressed to be equal to or less than a predetermined limitation value. Thereby, when a variation amount of the frequency value is large between the distribution levels in the neighboring-classes block, the variation becomes gradual.

In the filter device, the image correction circuit, the image display device, and the method of correcting the image according to the embodiment of the present invention, a filtering operation is performed on the input image data so that, when time-varying amount in a total frequency value in a neighboring-classes block configured with a couple of neighboring classes in the histogram distribution of the image data is equal to or less than a predetermined value, time-varying amount of a frequency value in each of the classes in the neighboring-classes block is suppressed to be equal to or less than a predetermined limitation value. Thereby, even when a variation amount of the frequency value is large between the distribution levels in the neighboring-classes block, the variation becomes gradual. Therefore, at the time of performing the image processing for image data through use of the histogram distribution after such a filtering operation, it is possible to suppress an unnatural variation in image quality which is caused by image processing.

Other and further objects, features and advantages of the invention will appear more fully from the following description.

### BRIEF DESCRIPTION OF THE DRAWINGS

FIG. 1 is a block diagram indicating a configuration example of an image display device according to an embodiment of the present invention.

FIG. 2 is a block diagram indicating a configuration example of an image processing section in FIG. 1.

FIG. 3 is a characteristic view indicating an example of a light intensity distribution detected in a light intensity information detection section in FIG. 2.

FIG. 4 is a block diagram for explaining input data and output data to an adjacent filter in FIG. 2

FIG. 5 is a characteristic view indicating an example of contrast improvement processing with a γ correction section in FIG. 2

FIG. 6 is a schematic view for explaining operation of the adjacent filter.

FIG. 7 is a characteristic view for explaining operation of the adjacent filter.

FIGS. 8A and 8B are timing views indicating an example of operation of the adjacent filter.

FIGS. 9A and 9B are timing views indicating another example of operation of the adjacent filter.

FIGS. 10A and 10B are characteristic views of an operation example of the adjacent filter in FIGS. 8A and 8B.

FIGS. 11A and 11B are characteristic views of an operation example of the adjacent filter in FIGS. 9A and 9B.

FIGS. 12A and 12B are characteristic views for explaining operation of an adjacent filter according to a modification of the present invention.

FIG. 13 is a block diagram indicating the configuration of an image processing section according to the modification of the present invention.

FIG. 14 is a block diagram for explaining image processing through use of a light intensity distribution of the related art.

FIG. 15 is a characteristic view for explaining data transition between data immediately adjacent to each other in a light intensity distribution at the time of performing the image processing of the related art in FIG. 14.

FIG. 16 is a characteristic view for explaining a change in a γ correction curve which is caused by data transition between data immediately adjacent to each other in FIG. 15.

### DETAILED DESCRIPTION OF THE PREFERRED EMBODIMENT

A preferred embodiment of the present invention will be described in detail with reference to the accompanying drawings.

### Configuration Example of a Whole Image Display Device

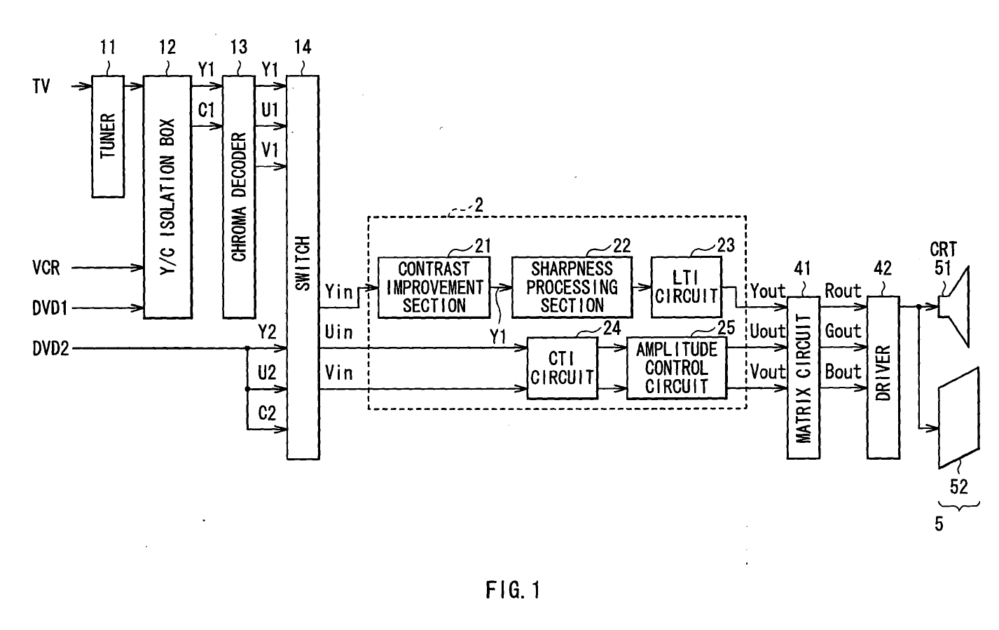

FIG. 1 indicates the overall configuration of an image display device according to an embodiment of the present invention. The image display device includes a tuner 11, a Y/C isolation circuit 12, a chroma decoder 13, a switch 14, an image processing section 2, a matrix circuit 41, a driver 42, and a display 5. Since a method of correcting an image according to an embodiment of the present invention is realized in the image display device according to the embodiment, the method of correcting an image will be also described below.

An image signal input to this image display device may be a television signal from a TV (television). In addition to this, the image signal may be an output from a VCR (video cassette recorder), a DVD (digital versatile disc), or the like. In this manner, image information is taken in from a plurality of types of media, and an image display is performed based on the image information. This is typical in a television and a personal computer (PC) in recent years.

The tuner 11 receives and demodulates a television signal from the TV, and outputs the television signal as a composite signal (CUBS; composite video burst signal).

The Y/C isolation circuit 12 outputs the composite signal from the tuner 11 as a luminance signal Y1 and a color signal C1, or outputs a composite signal from the VCR or the DVD1 as the luminance signal Y1 and the color signal C1, the luminance signal Y1 and the color signal C1 being isolated from each other in the Y/C isolation circuit 12.

The chroma decoder 13 outputs the luminance signal Y1 and the color signal C1 isolated from each other in the Y/C isolation circuit 12, as a YUV signal (Y1, U1, and V1) which is configured with the luminance signal Y1 and color difference signals U1 and V1.

The YUV signal is image data of a two-dimensional digital image, and a collection of pixel values corresponding to positions on the image. In the YUV signal, the luminance signal Y expresses a luminance level, and has an amplitude value between a white level of 100% white and a black level of 0% luminance. The image signal of 100% white is defined as 100 (IRE) in a unit expressing a relative ratio of an image signal, which is called IRE (institute of radio engineers). In the signal standards of NTSC (national television standards committee) in Japan, the white level is defined as 100 IRE, and the black level is defined as 0 IRE. Meanwhile, the color difference signal U corresponds to a signal B-Y in which the luminance signal Y is subtracted from blue (B), and the color difference signal V corresponds to a signal R-Y in which the luminance signal Y is subtracted from red (R). By combining the color difference signal U and the color difference signal V with the luminance signal Y, a color (color phase, chromaticness, and luminance) is expressed.

The switch 14 switches the YUV signal (here, the YUV signal (Y1, U1 and V1)) from a plurality of types of media, and a YUV signal (Y2, U2, and V2) from a DVD2, and thereby outputs the selected signal as a YUV signal (Yin, Uin, and Vin). The input from the DVD 2 to the switch 14 also includes a YUV output as being a decode output in digital broadcasting.

The image processing section 2 performs a predetermined image processing to the YUV signal (to each of Yin, Uin, and Vin), and generates a YUV signal (Yout, Uout, and Vout). The image processing section 2 includes a contrast improvement section 21, a sharpness processing section 22, an LTI (luminance transient improvement) circuit 23, a CTI (color transient improvement) circuit 24, and an amplitude control section 25.

The contrast improvement section 21 performs a predetermined contrast improvement to the luminance signal Yin, and generates a luminance signal Y3. The detailed configuration of the contrast improvement section 21 will be described later.

The sharpness processing section 22 performs a predetermined sharpness processing to the luminance signal Y3 supplied from the contrast improvement section 21.

The LTI circuit 23 is a circuit which improves a luminance transient of a signal whose transient waveform is gradual in the luminance signal after the sharpness processing. Such a luminance signal after the transient improvement processing is output as the luminance signal Yout from the image processing section 2.

The CTI circuit 24 is a circuit which improves a color transient of a signal whose transient waveform is gradual in the color difference signals Uin and Vin, such as a display image of a color bar.

The amplitude control section 25 performs a predetermined amplitude control to the color difference signal supplied from the CTI circuit 24, and generates the color difference signals Uout and Vout.

The matrix circuit 41 regenerates an RGB signal from the luminance signal Yout and the color difference signals Uout and Vout, to which the image processing is performed in the image signal section 2, and outputs the regenerated RGB signal (Rout, Gout, and Bout) to the driver 42.

The driver 42 generates a drive signal with respect to a display 5, based on the RGB signal (Rout, Gout, and Bout) output from the matrix circuit 41, and outputs the drive signal to the display 5.

The display 5 performs an image display based on the YUV signal (Yout, Uout and Vout) after the luminance correction and the color correction, in response to the drive signal output from the driver 42. The display 5 may be any types of display devices. For example, a CRT (cathode-ray tube) 51, an LCD (liquid crystal display) 52, a PDP (plasma display panel) which is not illustrated in the figure, or the like is used as the display 5.

### Configuration Example of the Contrast Improvement Section

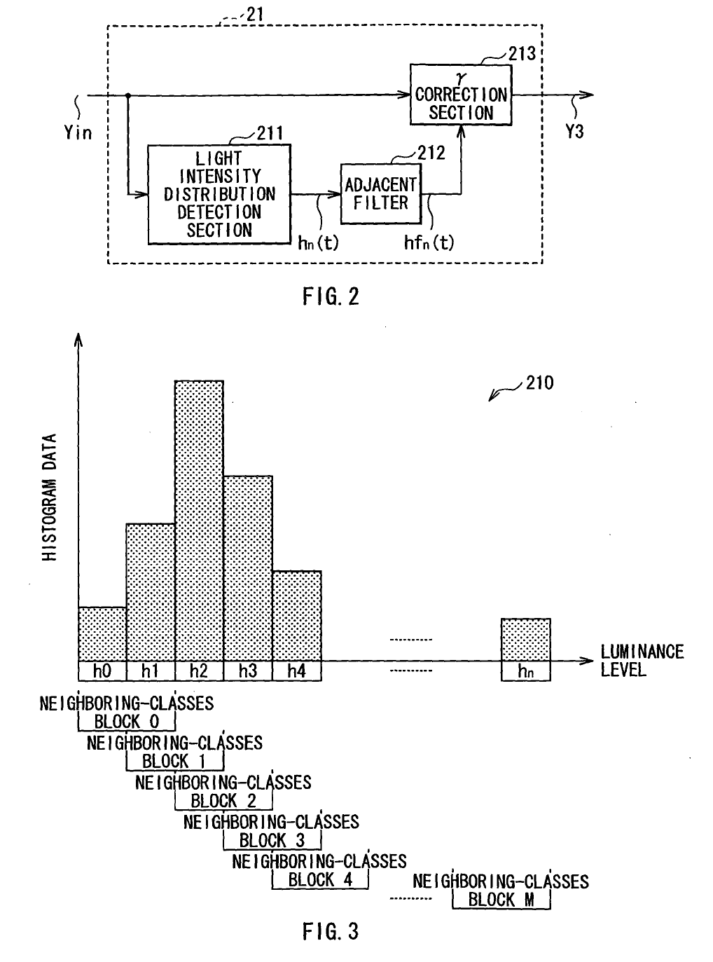

Next, with reference to FIGS. 2 to 5, the detailed configuration example of the contrast improvement section 21 will be described. FIG. 2 indicates an example of the block configuration of the contrast improvement section 21.

The contrast improvement section 21 includes a light intensity distribution detection section 211, an adjacent filter 212, and a γ correction section 213.

For example, as indicated in FIG. 3, the light intensity distribution detection section 211 detects a light intensity distribution 210 of a histogram distribution for each image frame in the luminance signal Yin. Here, in such a light intensity distribution 210, it is assumed that a luminance level (distribution level) from white (100 IRE) to black (0 IRE) is divided by the number of n (for example, the rough division number of approximately 128). A histogram amount (frequency value) in each luminance level class is expressed as h0 to hn. A block configured with two luminance level classes immediately adjacent to each other is expressed as a neighboring-classes block, and there are a neighboring-classes block 0 to a neighboring-classes block M (M=n−1).

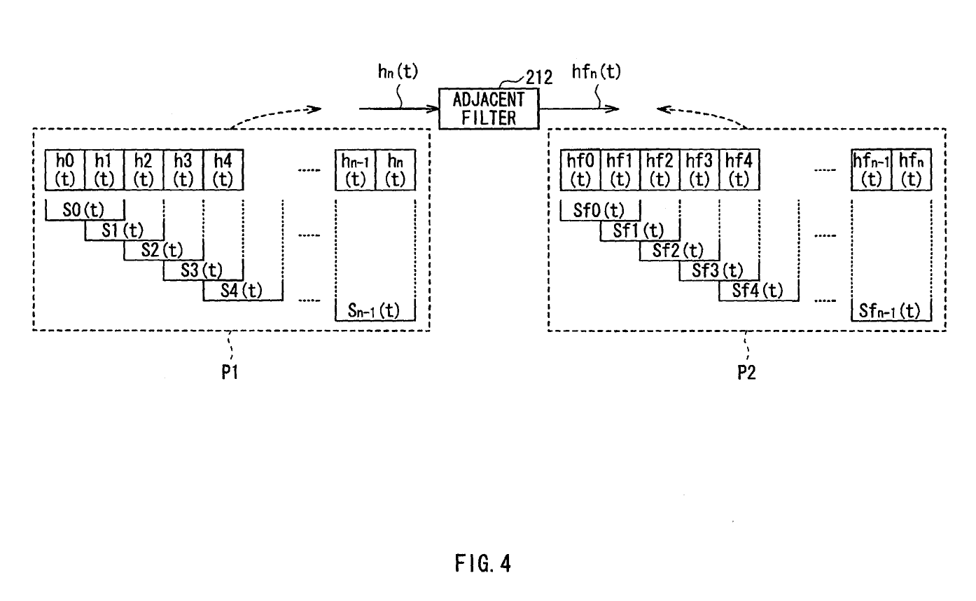

As indicated in FIGS. 2 and 4, the adjacent filter 212 performs a predetermined filtering operation which will be described later in the histogram distribution (collected data of input histogram amount hn (t)) supplied from the light intensity distribution detection section 211. The historgram distribution after such a filtering operation (collected data of output histogram amount hfn (t)) is output to the γ correction section 213. Each of the input histogram amount hn (t) and the output histogram amount hfn (t) indicates the histogram amount at a time “t”. As indicated with reference numerals P1 and P2 in FIG. 4, in an input and an output of the adjacent filter 212, a total value of histogram amounts of two luminance level classes in a neighboring-classes block “m” (m; 0 to (n−1)) is defined by formula (1) and formula (2) below.

Total input histogram amount Sm (t) of immediately adjacent luminance level classes

=hm(t)+hm+1(t) (1)

Total output histogram amount Sfm (t) of immediately adjacent luminance level classes

=hfm(t)+hfm+1(t) (2)

The γ correction section 213 performs a gamma correction (γ correction) to the luminance signal Yin through use of the histogram distribution after the filtering operation in the adjacent filter 212 (collected data of output histogram amount hfn (t)), and thereby generates a luminance signal Y3. Specifically, the γ correction section 213 adaptively determines a luminance gain of the γ curve for each image frame through use of the histogram distribution after the filtering operation.

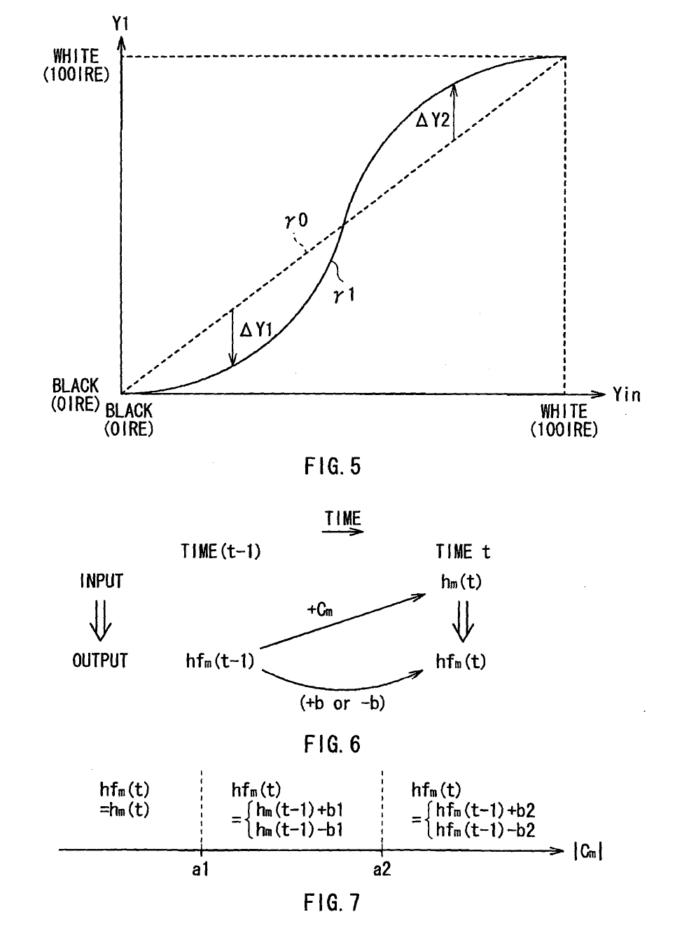

More specifically, for example, as indicated in FIG. 5, a luminance gain determined according to each luminance level class (for example, luminance correction amounts ΔY1 and ΔY2 in the figure) is added to a reference input/output characteristic line γ0 which indicates that the luminance signal Yin is equal to the luminance signal Y3. Thereby, an adaptive gamma curve γ1 is formed. With such a gamma curve γ1, light-dark adjustment for the luminance signal Yin is performed. In the gamma curve γ1, depending on the histogram amount in the histogram distribution after being subjected to the filtering operation, it is set that the light-dark difference becomes large in the vicinity of the luminance level class, where the frequency is high. Thereby, contrast improvement is efficiently performed.

Here, the contrast improvement section 21 corresponds to a specific example of “an image correction circuit” in the present invention. The light intensity distribution detection section 211 corresponds to a specific example of “a detection section” in the present invention. The adjacent filter 212 corresponds to a specific example of “a filter section” and “a filter device” in the present invention. The γ correction section 213 corresponds to a specific example of “an image processing section” in the present invention.

### Operational Description

Next, operation and effects of the image display device according to the embodiment will be described.

First, with reference to FIGS. 1 to 5, the basic operation of the image display device will be described.

The image signal input to the image display device is demodulated to the YUV signal. Specifically, the television signal from the TV is demodulated to be a composite signal in the tuner 11. From the VCR and the DVD1, the composite signal is directly input to the image display device. These composite signals are isolated to the luminance signal Y1 and the color signal C1 in the Y/C isolation circuit 12. The luminance signal Y1 and the color signal C1 are decoded to the YUV signal (Y1, U1, and V1) in the chroma decoder 13. Meanwhile, from the DVD2, the YUV signal (Y2, U2, and V2) is directly input to the image display device.

Next, in the switch 14, one of the YUV signal (Y1, U1, and V1) and the YUV signal (Y2, U2, and V2) is selected, and output as the YUV signal (Yin, Uin, and Vin). In the image signal processing section 2, the contrast improvement is performed in the contrast improvement section 21, to the luminance signal Yin of the YUV signal (Yin, Uin, and Vin). Thereby, the luminance signal Y3 is generated.

Here, in the contrast improvement section 21, the γ correction processing is performed in the γ correction section 213 through use of the histogram distribution based on the luminance signal Yin, the histogram distribution being obtained through the light intensity distribution detection section 211 and the adjacent filter 212. The luminance signal Y3 after such a γ correction processing (contrast improvement) is output to the sharpness processing section 22.

Next, the sharpness processing to the luminance signal Y3 is performed in the sharpness processing section 22, and the luminance transient improvement to the luminance signal Y3 is performed in the LTI circuit 23. Thereby, the luminance signal Y3 is output as the luminance signal Yout to the matrix circuit 41.

Meanwhile, in the image processing section 2, the color transient improvement to the color difference signals Uin and Vin of the YUV signal (Yin, Uin, and Vin) is performed in the CTI circuit 24, and then the predetermined amplitude control to the color difference signals Uin and Vin is performed in the amplitude control section 25. Thereby, the color difference signals Uin and Vin are output as the color difference signals Uout and Vout to the matrix circuit 41.

Next, in the matrix circuit 41, the input luminance signal Yout and the input color difference signals Uout and Vout are regenerated as the RGB signal (Rout, Gout, and Bout). In the driver 42, the drive signal is generated based on this RGB signal, and an image is displayed on the display 5 based on the drive signal.

Next, with reference to FIGS. 6, 7, 8A, 8B, 9A, 9B, 10A, 10B, 11A, and 11B, operation of the adjacent filter 212 as one of characteristic parts in the present invention will be described.

In a predetermined case, in the input histogram distribution (collected data of input histogram amount hn (t)), the adjacent filter 212 performs the filtering operation which limits, to be equal to or smaller than a predetermined limitation value, the time-varying amount of the histogram amount in each of the luminance level classes in the neighboring-classes block. This is because, in the case where the histogram amount is concentrated to a boundary of a couple of luminance level classes immediately adjacent to each other, even when the histogram amount is shifted in the neighboring-classes block, a total histogram amount in the neighboring-classes block (total input histogram amount Sm (t) of the immediately adjacent luminance level classes in the neighboring-classes block) may not change in many cases. Therefore, the adjacent filter 212 performs the above-described filtering operation when the time-varying amount of the total input histogram amount Sm (t) of the immediately adjacent luminance level classes in the neighboring-classes block is equal to or smaller than a predetermined value (threshold “d” indicated below). Specifically, when formula (3) below is established, the filtering operation is performed. When formula (3) is not established, the filtering operation is stopped.

|Sm(t)−Sfm(t−1)|≦d (3)

For example, as indicated in FIG. 6, depending on a difference value Cm between the output histogram amount hfm (t−1) at a time (t−1) and the input histogram amount hm (t) at the time “t”, the adjacent filter 212 performs the filtering operation. That is, depending on the difference value Cm, the time-varying amount (here, the time-varying amount from hfm (t−1) to hfm (t)) of the histogram amount in each of the luminance level classes in the corresponding neighboring-classes block is limited to be equal to or smaller than the predetermined limitation value (+b or −b). Thereby, when the difference value Cm is large, the output histogram amount hfm (t) gradually approaches the input histogram amount hm (t) while spending a certain time.

Specifically, for example, as indicated in FIG. 7, the adjacent filter 212 performs the filtering operation. That is, when an absolute value |Cm| of the difference value is larger than a difference threshold a1, depending on the absolute value |Cm|, the time-varying amount from hfm (t−1) to hfm (t) is limited in multi-stages (here, two stages). On the other hand, when the absolute value |Cm| of the difference value is equal to or smaller than the above-mentioned difference threshold a1, the filtering operation is not performed (that is, hfm (t)=hm (t)), thereby to allow the output histogram amount in each of the luminance level classes in the neighboring-classes block to come to the input histogram amount.

More specifically, the adjacent filter 212 performs the filtering operation as will be described below.

### [I] Calculation of hfm (t) in the Neighboring-Classes Block

1. Case where the Relationship Below is Established:

difference threshold a2<absolute value |Cm| of difference value

When Cm≧0, the calculation of hfm (t) is performed with formula (4) below. When Cm<0, the calculation of hfm (t) is performed with formula (5) below. Thereby, in both of the cases, the time-varying amount from hfm (t−1) to hfm (t) is limited to be equal to or smaller than a predetermined limitation value b2.

hfm(t)=hfm(f−1)+b2 (4)

hfm(t)=hfm(f−1)−b2 (5)

2. Case where the Relationship Below is Established:

difference threshold a1<|Cm|≦difference threshold a2

When Cm≧0, the calculation of hfm (t) is performed with formula (6) below. When Cm<0, the calculation of hfm (t) is performed with formula (7) below. Thereby, in both of the cases, the time-varying amount from hfm (t−1) to hfm (t) is limited to be equal to or smaller than a predetermined limitation value b1.

hfm(t)=hfm(f−1)+b1 (6)

hfm(t)=hfm(f−1)−b1 (7)

3. Case where the Relationship Below is Established:

|Cm|≦difference threshold a1

As formula (8) below, the filtering operation is stopped, and thereby the histogram amount of each of the luminance level classes in the neighboring-classes block is converged.

hfm(t)=hm(t) (8)

[II] Calculation of hfm+1 (t) in the Neighboring-Classes Block

Similarly to 1. to 3. in [I], the filtering operation is performed depending on the absolute value |Cm+1| of the difference value, and thereby hfm+1 (t) is calculated.

The neighboring-classes block is configured so that a first and a second neighboring-classes blocks share one class, the first neighboring-classes block being defined as a block including the one class as a higher class of the couple of classes, the second neighboring-classes block being defined as a block including the one class as a lower class of the couple of classes. In each luminance level class, the adjacent filter 212 finally determines the limitation value by taking into account both of a first limitation value A (for example, b1 and b2) in the first neighboring-classes block, and a second limitation value B (for example, b1 and b2) in the second neighboring-classes block

Specifically, the adjacent filter 212 may finally determine the difference threshold based on the difference threshold a1 in the first neighboring-classes block and the difference threshold a2 in the second neighboring-classes block, and may finally determine the limitation value based on the first limitation values A in the first neighboring-classes block and the second limitation value B in the second neighboring-classes block. That is, usually, the same difference threshold and the same limitation value are used for both of the first neighboring-classes block and the second neighboring-classes block. The filtering operation is repeated from the first-neighboring classes block to the second-neighboring classes block, or the filtering operation is repeated from the second neighboring-classes block to the first neighboring-classes block. Thereby, the output histogram amount is converged to the final input histogram amount. Alternatively, it is also possible that the difference thresholds different from each other are used for the first neighboring-classes block and the second neighboring-classes block and the limitation values different from each other are used for the first neighboring-classes block and the second neighboring-classes block. Thus, the convergent speed is separately set for the first neighboring-classes block and the second neighboring-classes block. With such a method, it is possible that the difference threshold 1a and the limitation value b1 are set to small values, and smoother convergence is realized.

Such a filtering operation is continuously performed to all the neighboring-classes blocks, and thereby the adjacent filter which smoothes the histogram change between the immediately adjacent luminance level classes in the neighboring-classes block is realized. At this time, it is possible to adjust the convergent time (convergent speed) with the difference thresholds a1 and a2, and the limitation values b1 and b2.

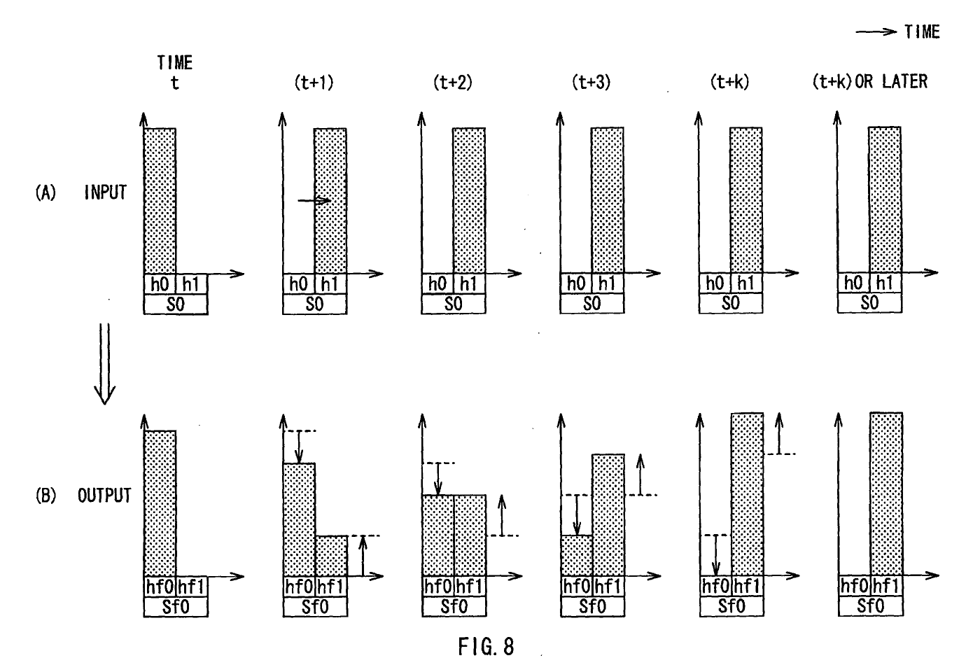

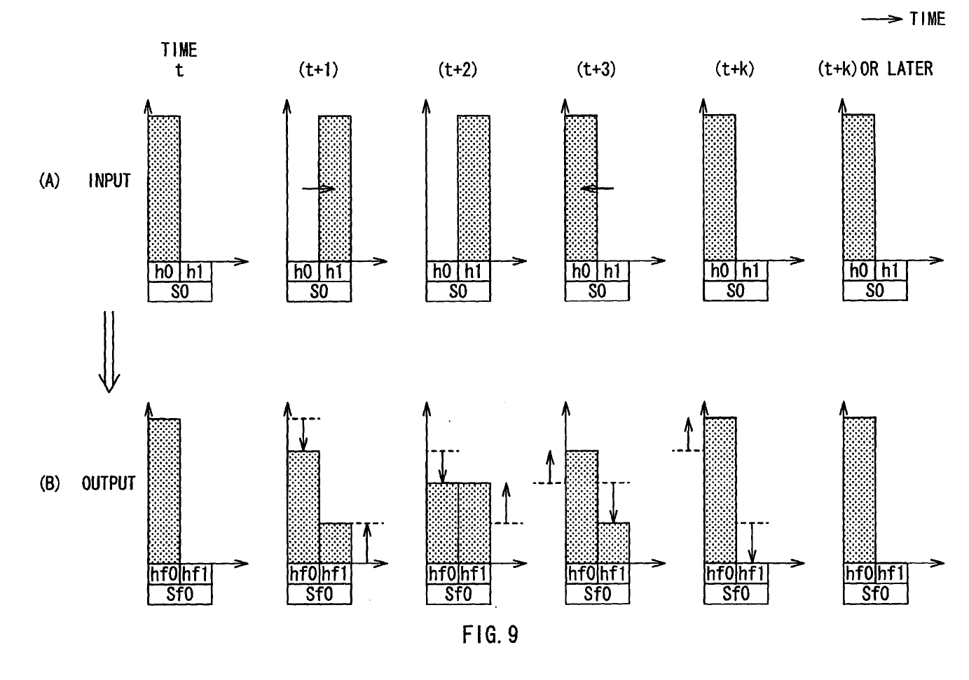

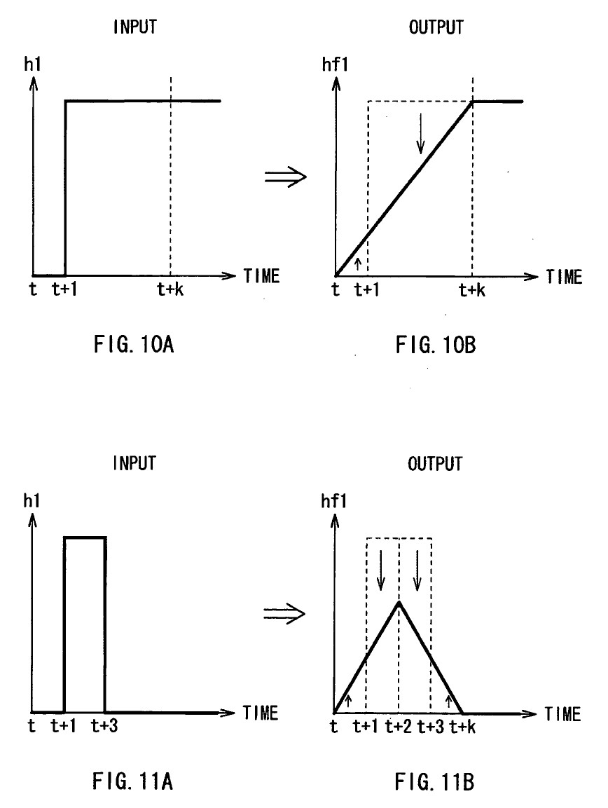

As indicated with arrows in FIGS. 8A, 8B, 9A, and 9B, in the case where the histogram amount is shifted between the immediately adjacent histograms, the histogram amount in the course of changing is interpolated by using the adjacent filter 212, and thereby the histogram amount smoothly changes while spending a certain time. Therefore, for example, as indicated with arrows in FIGS. 10A, 10B, 11A, and 11B, even in the case where there is a large variation amount of the histogram amount between the luminance level classes in the neighboring-classes blocks, the variation becomes gradual.

As the limitation values b1 and b2 are set smaller, convergence becomes smoother, but the time for convergence becomes long. Thus, the histogram amount is converged by momentarily changing the difference thresholds a1 and a2, and the limitation values b1 and b2, and thereby the convergent speed at the time of convergence may be adjusted.

In this manner, in the embodiment, when the time-varying amount of the total input histogram amount Sm (t) of immediately adjacent luminance level classes is equal to or smaller than the threshold “d” in the histogram distribution (light intensity distribution 210) of the luminance signal Yin, the filtering operation is performed so that the time-varying amount of the histogram amount in each of the luminance level classes in the neighboring-classes block is limited to be equal to or smaller than the predetermined limitation value. Therefore, even in the case where the variation amount of the histogram amount is large between the luminance level classes in the neighboring-classes block, the variation becomes gradual. Accordingly, when the image processing is performed to the image data through use of the histogram distribution after such a filtering operation, it is possible to suppress the unnatural variation in image quality which is caused by the image processing.

Even in the case where the histogram amount is in the vicinity of a boundary between the couple of divided luminance level classes, and the histogram amount is shifted over the boundary from the lower luminance level class to the higher luminance level class, or shifted over the boundary from the higher luminance level class to the lower luminance level class, it is possible that the variation of the histogram amount becomes gradual through use of the adjacent filter 212 according to the embodiment.

There is a tendency that the variation amount of the divided histogram amount is large, as the number of divisions is small. However, by using the adjacent filter 212 according to the embodiment, it is possible that the variation amount is dispersed in a time direction, and the time-varying amount is suppressed.

Even in the case where the histogram amount is frequently shifted, it is possible to reduce the variation amount.

Since the convergent time of the histogram and thus the convergent time of the outputs of the signal processing may be arbitrarily adjusted, the output change as intended is possible. Therefore, it is possible to establish a stable signal processing system as a result.

Since the histogram distribution may be divided with the rough division number, it is possible that the scale of the hardware is small, and the device configuration is simplified. Therefore, it is possible to reduce the manufacture cost.

Moreover, unlike an IIR (infinite impulse response) filter of the related art, since the filtering operation is performed only in the predetermined case (in the case where formula (3) above is satisfied), it is possible to avoid unnecessary filtering operation. Therefore, the response is slow only at the time of a phenomenon of sudden change of an image, in which brightness in a whole screen instantaneously changes, the sudden change of the image being caused by the small number of divisions in the histogram. Accordingly, the response characteristics are improved, or pakatuski is efficiently suppressed, in comparison with the case where the filtering operation is performed in the same way in all cases with the IIR filter.

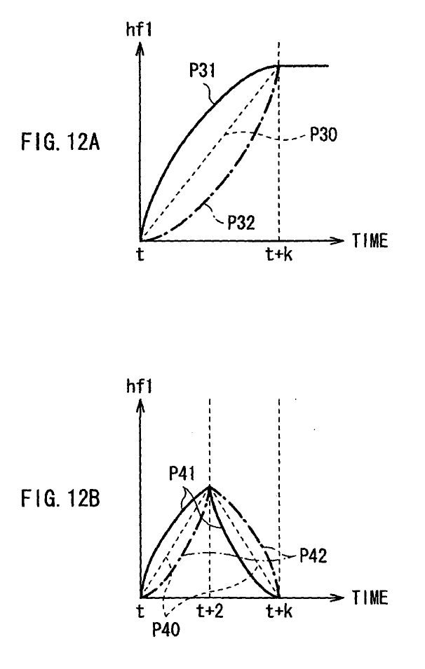

In the embodiment, for example, as indicated with reference numerals P30 and P40 in FIGS. 12A and 12B, the case where the output histogram amount hfm (t) is temporally changed is described. However, the way of changing is not limited to this. Specifically, the output histogram amount hfm (t) may be temporally changed as indicated with reference numerals P31 and P41 and reference numerals P32 and P42 in the figures. In this case, the changes as indicated with reference numerals P31 and P41 are converged faster, and thus preferable. In this case, for example, it is preferable that two or more points are placed between a time “t” and a time (t+1) in the changes of reference numerals P31 and P41 and these points are connected with three or more straight lines.

Hereinbefore, although the present invention is described with the embodiment, the present invention is not limited to this and various modifications may be made.

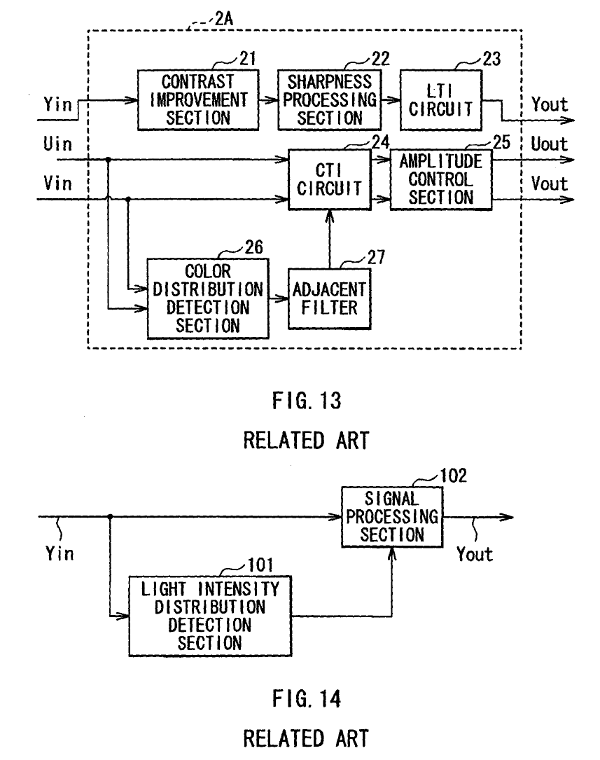

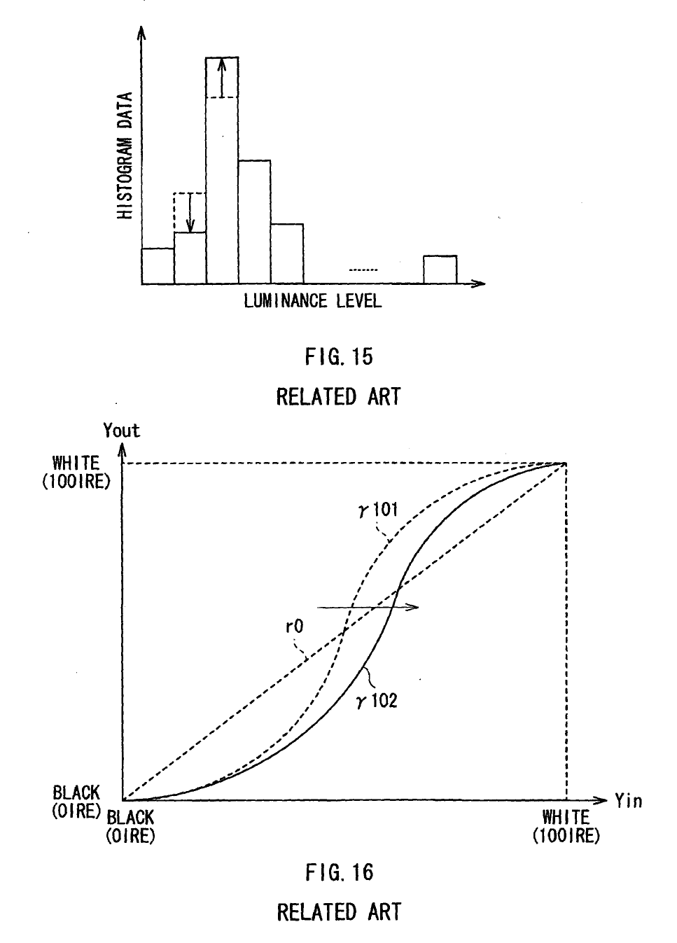

For example, although the case is described where the adjacent filter performs the filtering operation in the luminance histogram distribution based on the luminance signal in the image data, the adjacent filter may perform the filtering operation in a color histogram distribution based on a color signal. Specifically, for example, like an image processing section 2A in FIG. 13, there may be provided a color distribution detection section 26 detecting a color histogram distribution in color difference signals Uin and Vin, and an adjacent filter 27 performing, in the color histogram distribution, the filtering operation according to the embodiment. In this case, for example, in a CTI circuit 24, the image processing is performed through use of the color histogram distribution after the filtering operation with such an adjacent filter 27. Specifically, as the color histogram distribution, for example, there is a histogram distribution based on depth of colors. In addition to this, there is a histogram distribution based on types of colors (Hue). As an application of this, the color histogram distribution may be applied to detection of a flesh color and a specific red color. That is, the adjacent filter 27 is used at the time of performing the color processing to detect flesh color, and thereby it is possible to avoid a rapid change of an image (sudden change of an image) after the processing, even in the case where the number of divisions in the histogram is set small at the time of detecting the flesh color.

In the configuration of the image processing section 2 described in the embodiment, other processing section may be added, or an existing processing section may be substituted with other processing section, as long as the configuration of the contrast improvement section 21 is not changed.

In the embodiment, the case where the image data is expressed with a YUV signal is described. However, in addition to this, the image data may be expressed with an RGB signal or an HSV signal

It is not limited that the filter device and the image correction circuit according to the embodiment of the present invention are applied to the image display device as described in the embodiment. The filter device and the image correction circuit may be applied to other devices which use image data.

Moreover, the series of processes described in the embodiment may be performed with hardware, or software. In the case where the series of processes are performed with software, a program constituting the software is installed in a versatile computer or the like. Such a program may be installed in advance in record medium embedded in a computer.

It should be understood by those skilled in the art that various modifications, combinations, sub-combinations and alterations may occur depending on design requirements and other factors insofar as they are within the scope of the appended claims or the equivalents thereof.

What is claimed is:

1. A filter device comprising:
a filter section performing a filtering operation on an input image data so that, when time-varying amount in a total frequency value in a neighboring-classes block configured with a couple of neighboring classes in a histogram distribution of the input image data is equal to or less than a predetermined value, time-varying amount of a frequency value in each of the classes in the neighboring-classes block is suppressed to be equal to or less than a predetermined limitation value.

2. The filter device according to claim 1, wherein
the filter section controls the time-varying amount of the frequency value in each of the classes in the neighboring-classes block to be suppressed equal to or less than the predetermined limitation value, according to a difference value between a frequency value in each of the classes after the filtering operation on a histogram distribution at a timing and a frequency value in each of the classes before the filtering operation on a histogram distribution at a following timing.

3. The filter device according to claim 2, wherein
when the difference value is larger than a predetermined difference threshold, the filter section controls severity of the filtering operation to be changed according to the difference value, while
when the difference value is equal to or smaller than the predetermined difference threshold, the filter section stops the filtering operation.

4. The filter device according to claim 3, wherein the filter section dynamically changes the limitation value and the difference value, thereby to adjust a convergent speed which is defined as a speed of convergence of the frequency value in each of the classes in the neighboring-classes block.

5. The filter device according to claim 3, wherein
the neighboring-classes block is configured so that a first and a second neighboring-classes blocks share one class, the first neighboring-classes block being defined as a block including the one class as a higher class of the couple of classes, the second neighboring-classes block being defined as a block including the one class as a lower class of the couple of classes, and
the filter section finally determines the difference threshold based on both of a first difference threshold in the first neighboring-classes block and a second difference threshold in the second neighboring-classes block, and finally determines the limitation value based on both of a first limitation value in the first neighboring-classes block and a second limitation value in the second neighboring-classes block.

6. The filter device according to claim 5, wherein
the filter section determines the difference threshold through weighted summation of the first and the second difference thresholds, and determines the limitation value through weighted summation of the first and the second limitation values.

7. The filter device according to claim 1, wherein the filter section performs the filtering operation on a luminance histogram distribution which represents a histogram distribution of luminance signal in the input image data.

8. The filter device according to claim 1, wherein the filter section performs the filtering operation on a color histogram distribution which represents a histogram distribution of color signal in the input image data.

9. An image correction circuit comprising:
a detection section detecting a histogram distribution of an input image data;
a filter section performing a filtering operation on the input image data so that, when time-varying amount in a total frequency value in a neighboring-classes block configured with a couple of neighboring classes in the histogram distribution detected in the detection section is equal to or less than a predetermined value, time-varying amount of a frequency value in each of the classes in the neighboring-classes block is suppressed to be equal to or less than a predetermined limitation value; and
an image processing section performing an image processing on the input image data through use of the histogram distribution after the filtering operation in the filter section.

10. An image display device comprising:
a detection section detecting a histogram distribution in an image frame of an input image data;
a filter section performing a filtering operation on the input image data so that, when time-varying amount in a total frequency value in a neighboring-classes block configured with a couple of neighboring classes in the histogram distribution detected in the detection section is equal to or less than a predetermined value, time-varying amount of a frequency value in each of the classes in the neighboring-classes block is suppressed to be equal to or less than a predetermined limitation value;
an image processing section performing an image processing on the input image data through use of the histogram distribution after the filtering operation in the filter section; and
a display section displaying an image based on the image data after the image processing in the image processing section.

11. A method of correcting an image comprising:
detecting a histogram distribution of an input image data;
performing a filtering operation on the input image data so that, when time-varying amount in a total frequency value in a neighboring-classes block configured with a couple of neighboring classes in the detected histogram distribution is equal to or less than a predetermined value, time-varying amount of a frequency value in each of the classes in the neighboring-classes block is suppressed to be equal to or less than a predetermined limitation value; and
performing an image processing on the input image data through use of the histogram distribution after the filtering operation.
